(19) United States
(12) Patent Application Publication
(10) Pub. No.: US 2012/0162725 A1
(43) Pub. Date: Jun. 28, 2012

(54) Optical System for Scanners

(76) Inventors: Eugene David Allen, Richmond, KY (US); Chengwu Cui, Lexington, KY (US); Joshua Tyler Strow, Lexington, KY (US)

(21) Appl. No.: 12/979,685

(22) Filed: Dec. 28, 2010

(51) Int. Cl. H04N 1/04

(52) U.S. Cl. 358/475

(57) ABSTRACT

Disclosed is an optical system for a scanner that includes at least one light source to illuminate a document, and a plurality of mirrors including a first mirror, a second mirror, a third mirror, a fourth mirror and a fifth mirror. The first mirror is positioned in a direction of the document to receive a light beam therefrom. The second mirror is adapted to receive the light beam reflected from the first mirror. The third mirror is positioned in proximity to the document and is adapted to receive the light beam reflected from the second mirror. The fourth mirror is positioned substantially opposite to the third mirror for receiving the light beam reflected therefrom. The fifth mirror is positioned adjacent to the second mirror and is adapted to receive the light beam reflected from the fourth mirror. The optical system further includes an imaging lens unit and an image sensor.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to scanners, and more particularly, to an optical system for a scanner.

2. Description of the Related Art

Typically, a scanner includes one or more scan heads that are available in two is types of designs for forming scanned images. A first design of the two types of the designs employs an array of thin rod lens to form a line image onto a 1:1 ratio sensor array, which is called a contact image sensor. A second design of the two types of the designs employs folding mirrors to form a reduced image via a lens onto a sensor array, and is often referred to as ‘optical reduction system’. The optical reduction system holds many advantages over the contact image sensor in terms of image quality. However, a scan head of the second design, i.e., a scan head having an optical reduction system therewithin, is usually bulkier than a scan head of the first design, i.e., a scan head having a contact image sensor therewithin. It has been observed that the folding mirrors and lens structure may be laid in many different ways in order to achieve a compact optical reduction system within the scan head.

Traditionally, most document scanners based on the optical reduction system have one scan head that is usually contained within a flatbed chamber. Additionally, an automatic document feeder (ADF) window is used for both simplex scan and duplex scan with a re-circulating paper path in the aforementioned type of document scanners. However, vertical dimension of such scanners needs to be small in order to address the problems associated with bulkiness of the scan head. Further, it is often advantageous to have small vertical as well as horizontal dimensions for scanners that employ two scan heads for duplex scans.

Various optical systems/layouts have been devised to attend to the aforesaid problems. For example, there exists an optical layout that employs 3 mirrors to fold an optical path of light with one mirror being used twice for a scanner. However, such an optical system is disadvantageous in constraining the vertical dimension of the scanner. Further, another optical layout for a scanner exists that employs 4 pieces of mirrors and arranges two pairs of mirrors in a parallel orientation, i.e., horizontally to form multiple reflections. However, such an optical system is also disadvantageous when considering the need of a narrower vertical dimension. Furthermore, yet another optical layout for a scanner is employs 3 pieces of mirrors, and allows a relatively narrower vertical dimension of the scanner, but requires a relatively longer horizontal dimension. Another alternate optical layout for a scanner exists that employs 7 pieces of mirrors to achieve compactness. However, such an optical system employs a large number of mirrors and may be associated with manufacturing complexities. Accordingly, it is desired that an optical system for a scanner is easy-to-manufacture in addition to being compact. For example, when 1 piece of mirror is used for more than one reflection, there may be one less degree of adjustment available for the mirror. Further, width of the mirror also needs to be sufficiently large when an angle of reflection is substantially larger than 45 degrees. Additionally, multiple reflections from a single mirror may be potentially prone to ghosting thereby affecting optical image quality.

Accordingly, there persists a need for an optical system that facilitates in achieving compact dimensions for a scanner, while maintaining high optical image quality.

### SUMMARY OF THE DISCLOSURE

In view of the foregoing disadvantages inherent in the prior art, the general purpose of the present disclosure is to provide an optical system for a scanner, by including all the advantages of the prior art, and overcoming the drawbacks inherent therein.

The present disclosure provides an optical system for a scanner. The optical system includes at least one light source to illuminate a document to be scanned. The optical system further includes a plurality of mirrors. The plurality of mirrors includes a first mirror positioned in a direction of the document. The first mirror is adapted to receive a light beam from the document illuminated with the at least one light source. Further, the first mirror is adapted to reflect the light beam. The plurality of mirrors includes a second mirror adapted to receive the light beam reflected from the first mirror. Further, the second mirror is adapted to reflect the received light beam across an optical path between the first mirror and the document.

The plurality of mirrors also includes a third mirror positioned in proximity to the document. The third mirror is adapted to receive the light beam reflected from the second mirror. The third mirror is further adapted to reflect the received light beam across the optical path between the first mirror and the document. In addition, the plurality of mirrors includes a fourth mirror positioned adjacent to the second mirror and substantially opposite to is the third mirror for receiving the light beam reflected from the third mirror. The fourth mirror is further adapted to reflect the received light beam across an optical path between the first mirror and the second mirror, and an optical path between the second mirror and the third mirror. Moreover, the optical system includes a fifth mirror positioned adjacent to the second mirror and in a direction of the fourth mirror such that the second mirror is set between the fourth mirror and the fifth mirror. The fifth mirror is adapted to receive the light beam reflected from the fourth mirror. The fifth mirror is further adapted to reflect the received light beam across the optical path between the first mirror and the document.

The optical system also includes an imaging lens unit positioned in a direction of the fifth mirror, and adapted to receive the light beam reflected from the fifth mirror. Furthermore, the optical system includes an image sensor positioned adjacent to the imaging lens unit, and adapted to sense an image formed by the imaging lens unit on the image sensor. The image is formed by focusing the received light beam on the image sensor. Further, the image corresponds to the document.

### BRIEF DESCRIPTION OF THE DRAWINGS

The above-mentioned and other features and advantages of the present disclosure, and the manner of attaining them, will become more apparent and will be better understood by reference to the following description of embodiments of the disclosure taken in conjunction with the accompanying drawings, wherein:

FIG. 1 depicts a layout of an optical system for a scanner, according to an embodiment of the present disclosure; and

FIG. 2 depicts an exemplary design for a charge-coupled device module that employs the optical system of the present disclosure.

### DETAILED DESCRIPTION

It is to be understood that various omissions and substitutions of equivalents are contemplated as circumstances may suggest or render expedient, but these are intended to cover the application or implementation without departing from the spirit or scope of the claims of the present disclosure. It is to be understood that the present disclosure is not limited in its application to the details of components set forth in the following description. The present disclosure is capable of other embodiments and of being practiced or of being carried out in various ways. Also, it is to be understood that the phraseology and terminology is used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item.

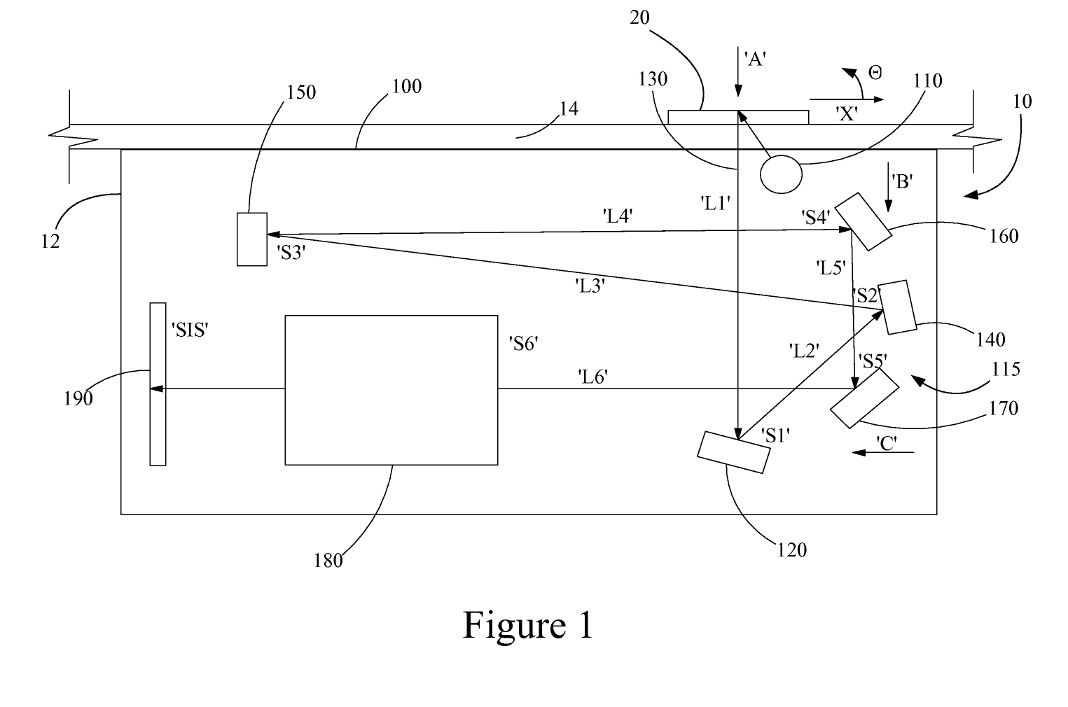

The present disclosure provides an optical system for a scanner. The optical system of the present disclosure includes an appropriate arrangement of a plurality of mirrors, an imaging lens unit and an image sensor, within the scanner in order to facilitate in achieving compact dimensions for the scanner. The term “dimension” as used herein, may relate to horizontal dimension and/or vertical dimension of the scanner, i.e., length, width and/or height of the scanner. The optical system of the present disclosure is explained in conjunction with FIG. 1.

FIG. 1 depicts a layout of an optical system 100 for a scanner 10, according to an embodiment of the present disclosure. For the purpose of this description, the scanner 10 is a flatbed scanner that includes a housing 12 (enclosure) and an image capture device/a scan head (not numbered). An example of the image capture device is a charge-coupled device module (CCDM). The scan head of the scanner 10 includes the optical system 100 of the present disclosure. During a scanning operation, the scan head of the scanner 10 that may be allowed to move across a document, such as a document 20, with the help of a driving unit, such as a stepper motor (not shown), to read image information of the document 20. Specifically, the scanner 10 includes a scanning window 14 configured within the housing 12 and adapted for carrying the document 20 thereon during the scanning operation. The scanning window 14 may be made of a material (such as a glass material) as known in the art. For the purpose of this description, FIG. 1 has been depicted to illustrate the optical system 100 of the scanner 10. However, it should be understood that the scanner 10 may include other components, such as a control circuitry, cooling fan and the like that have not been described and shown for the sake of simplicity.

The optical system 100 includes at least one light source, such as a light source 110, to illuminate the document 20 that needs to be scanned. For the purpose of this description, the optical system 100 is depicted to include only one light source 110. However, the optical system 100 may include more than one light source 110 based on a manufacturer's preferences. Further, the light source 110 may be in the form of a lamp such as a fluorescent lamp, a halogen lamp, and other such lamps known in the art for scanning operations. The optical system 100 may also include a reflector (not shown) to reflect a light beam from the light source 110 to efficiently illuminate the document 20.

Further, the optical system 100 includes a plurality of mirrors, and more specifically reflection mirrors. The plurality of mirrors includes a first mirror 120 positioned in a direction, such as a vertical direction ‘A’ of the document 20. The first mirror 120 is adapted to receive a light beam 130 from the document 20 when the document 20 is illuminated with the light source 110. Specifically, the light beam 130 is reflected along an optical path ‘L1’, and strikes at an incident surface ‘S1’ of the first mirror 120. The light beam 130 may correspond to an image of the document 20 to be scanned. Further, the first mirror 120 is adapted to reflect the light beam 130. The plurality of mirrors also includes a second mirror 140 adapted to receive the light beam 130 reflected from the first mirror 120 along an optical path ‘L2’. Specifically, the light beam 130 strikes at an incident surface ‘S2’ of the second mirror 140. Further, the second mirror 140 is adapted to reflect the received light beam 130 across the optical path ‘L1’ between the first mirror 120 and the document 20.

Moreover, the plurality of mirrors includes a third mirror 150 positioned in proximity to the document 20. The third mirror 150 is adapted to receive the light beam 130 reflected from the second mirror 140. Specifically, the light beam 130 is reflected along an optical path ‘L3’ from the second mirror 140 to the third mirror 150. More specifically, the light beam 130 strikes at an incident surface ‘S3’ of the third mirror 150. The third mirror 150 is further adapted to reflect the received light beam 130 across the optical path ‘L1’ between the first mirror 120 and the document 20. Further, the third mirror 150 may be capable of converging the light beam 130 being reflected therefrom. Furthermore, the third mirror 150 is an adjustable mirror, i.e., the position of the third mirror 150 may be adjusted in order to accommodate larger lens magnification error.

In addition, the plurality of mirrors includes a fourth mirror 160 positioned adjacent to the second mirror 140 and substantially opposite to the third mirror 150 for receiving the light beam 130 reflected from the third mirror 150. Specifically, the light beam 130 is reflected along an optical path ‘L4’ from the third mirror 150 to the fourth mirror 160. More specifically, the light beam 130 strikes at an incident surface ‘S4’ of the fourth mirror 160. Further, the light beam 130 may be reflected as a narrow light beam from the third mirror 150 to the fourth mirror 160. Specifically, the light beam 130 striking at/hitting the fourth mirror 160 is substantially narrower, thereby facilitating in saving space for the optical system 100. Accordingly, the scanner 10 that includes the optical system 100 may be manufactured to have reduced vertical and horizontal dimensions.

The fourth mirror 160 is also adapted to reflect the received light beam 130 across the optical path ‘L2’ between the first mirror 120 and the second mirror 140, and the optical path ‘L3’ between the second mirror 140 and the third mirror 150.

Moreover, the optical system 100 includes a fifth mirror 170 positioned adjacent to the second mirror 140 and in a direction, such as a vertical direction ‘B’ of the fourth mirror 160 such that the second mirror 140 is set between the fourth mirror 160 and the fifth mirror 170. The fifth mirror 170 is adapted to receive the light beam 130 reflected from the fourth mirror 160. Specifically, the light beam 130 is reflected along an optical path ‘L5’ from the fourth mirror 160 to the fifth mirror 170. More specifically, the light beam 130 strikes at an incident surface ‘S5’ of the fifth mirror 170. The fifth mirror 170 is further adapted to reflect the received light beam 130 across the optical path ‘L1’ between the first mirror 120 and the document 20.

The optical system 100 also includes an imaging lens unit 180 positioned in a direction, such as a horizontal direction ‘C’ of the fifth mirror 170, and adapted to receive the light beam 130 reflected from the fifth mirror 170. Specifically, the light beam 130 is reflected along an optical path ‘L6’ from the fifth mirror 170 to the imaging lens unit 180, and more particularly, to an incident surface ‘S6’ of the imaging lens unit 180. The imaging lens unit 180 may include one or more lens.

Furthermore, the optical system 100 includes an image sensor 190 positioned adjacent to the imaging lens unit 180, and adapted to sense an image formed by the imaging lens unit 180 on the image sensor 190. The image is formed by focusing the received light beam 130 on the image sensor 190. Further, the image corresponds to the document 20. The image sensor 190 may be in the form of a charge-coupled device array and may serve as a reading means. The optical system 100 may also include a filter (not shown) adjacent to the imaging lens unit 180 in order to facilitate the imaging lens unit 180 to focus the light beam 130 onto the image sensor 190 through the filter.

As depicted in FIG. 1, the first mirror 120 is positioned optically farthest from the document 20 among the plurality of mirrors, and in proximity to the imaging lens unit 180. Accordingly, the aforementioned arrangement of the first mirror 120 that is positioned further away from a plane of the document 20 makes dust inevitably less visible on the first mirror 120, as the light beam 130 may be more defocused when striking at the incident surface ‘S1’ of the first mirror 120.

Further, the first mirror 120, the second mirror 140, the fourth mirror 160 and the fifth mirror 170 may be mounted within a first bracket (not shown) configured within the housing 12 of the scanner 10. Furthermore, the third mirror 150 may be mounted within a second bracket (not shown) configured opposite to the first bracket within the housing 12 of the scanner 10. Additionally, without departing from the scope of the present disclosure, one or more mirrors, such as the third mirror 150, of the plurality of mirrors may be slightly curved to focus the reflected light beam 130 onto a respective smaller surface of a consecutive mirror, such as the fourth mirror 160.

As depicted in FIG. 1, the optical path ‘L6’ between the fifth mirror 170 and the imaging lens unit 180 is parallel to the optical path ‘L4’ between the third mirror 150 and the fourth mirror 160. Further, the optical path ‘L6’ between the fifth mirror 170 and the imaging lens unit 180 is perpendicular to the optical path ‘L5’ between the fourth mirror 160 and the fifth mirror 170. Similarly, the optical path ‘L4’ between the third mirror 150 and the fourth mirror 160 is perpendicular to the optical path ‘L5’ between the fourth mirror 160 and the fifth mirror 170. Specifically, a plane connecting the image sensor 190, the imaging lens unit 180, and the fifth mirror 170 is parallel to a plane connecting the third mirror 150 and the fourth mirror 160, and to the plane of the document 20. Such an arrangement facilitates in aligning the plurality of mirrors and manufacturing of the scanner 10 in an easy manner.

For the purpose of this description, only one light beam has been depicted. However, it should be understood that more than one light beams may be reflected in the above described sequence, i.e., from the document 20 to the first mirror 120, then from the first mirror 120 to the second mirror 140, then from the second mirror 140 to the third mirror 150, then from the third mirror 150 to the fourth mirror 160, then from the fourth mirror 160 to the fifth mirror 170, and finally from the fifth mirror 170 to the imaging lens unit 180.

In use, a document, such as the document 20, to be scanned is placed over the is scanning window 14. When power is provided to the scanner 10 for a scanning operation, the light source 110 illuminates the document 20. Subsequently, the light beam 130 strikes at the incident surface ‘S1’ of the first mirror 120 along the optical path ‘L1’. Thereafter, the light beam 130 is reflected from the first mirror 120 onto the incident surface ‘S2’ of the second mirror 140 along the optical path ‘L2’. The light beam 130 is then reflected from the second mirror 140 onto the incident surface ‘S3’ of the third mirror 150 along the optical path ‘L3’. Subsequently, the light beam 130 is reflected from the third mirror 150 onto the incident surface ‘S4’ of the fourth mirror 160 along the optical path ‘L4’. Thereafter, the light beam 130 is reflected from the fourth mirror 160 onto the incident surface ‘S5’ of the fifth mirror 170 along the optical path ‘L5’. The light beam 130 is then reflected from the fifth mirror 170 onto the incident surface ‘S6’ of the imaging lens unit 180 that focuses the light beam 130 for forming the image onto the image sensor 190.

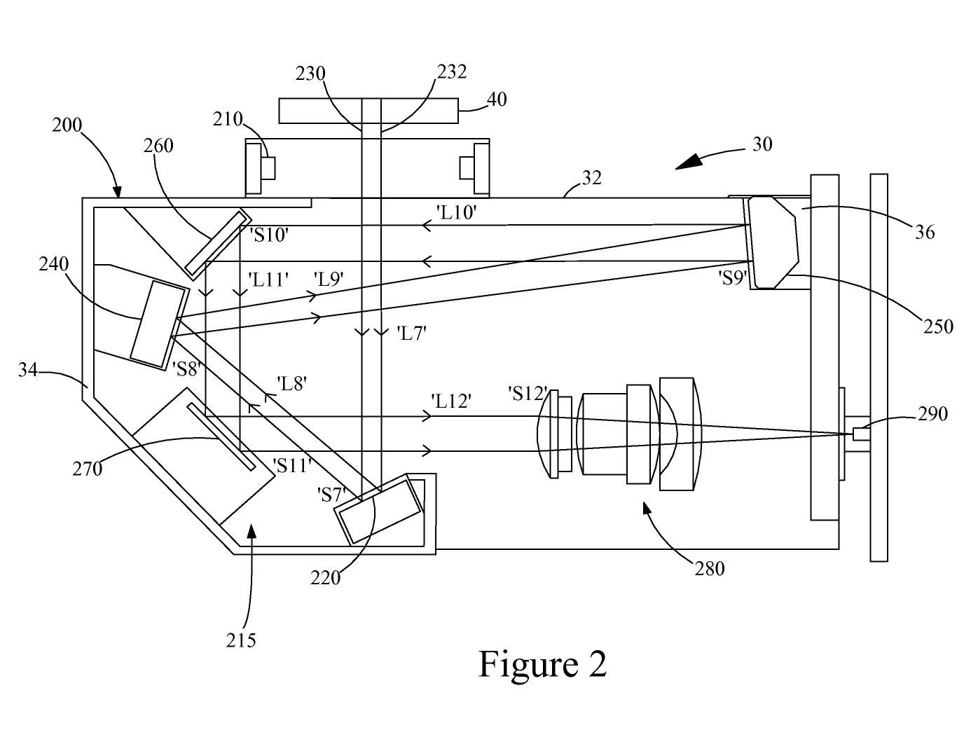

FIG. 2 depicts an exemplary design for a charge-coupled device module (CCDM) 30 of a scanner (similar to the scanner 10) that employs an optical system 200. The CCDM 30 has a housing 32 that includes the optical system 200 therewithin.

The optical system 200 is similar to the optical system 100 of FIG. 1, and includes at least one light source, such as a light source 210 similar to the light source 110 of the optical system 100, to illuminate a document, such as a document 40 that needs to be scanned. Further, the optical system 200 includes a plurality of mirrors, and more specifically reflection mirrors. The plurality of mirrors includes a first mirror 220 similar to the first mirror 120 and positioned in a vertical direction of the document 40; a second mirror 240 similar to the second mirror 140; a third mirror 250 similar to the third mirror 150 and positioned in proximity to the document 40; a fourth mirror 260 similar to the fourth mirror 160, and positioned adjacent to the second mirror 240 and substantially opposite to the third mirror 250; and a fifth mirror 270 similar to the fifth mirror 170, and positioned adjacent to the second mirror 240 and in a vertical direction of the fourth mirror 260. The optical system 200 also include an imaging lens unit 280 positioned in a horizontal direction of the fifth mirror 270. The imaging lens unit 280 is similar to the imaging lens unit 180 and may include one or more lens. Further, the optical system 200 includes an image sensor 290 (such as a charge-coupled device array) positioned adjacent to the imaging lens unit 280, and adapted to sense an image formed by the imaging lens unit 280 on the image sensor 290. The is image corresponds to the document 40.

The first mirror 220 is positioned optically farthest from the document 40 and in proximity to the imaging lens unit 280. Further, the first mirror 220, the second mirror 240, the fourth mirror 260 and the fifth mirror 270 are mounted within a first bracket 34 configured within the housing 32 of the CCDM 30 of the scanner. Furthermore, the third mirror 250 is mounted within a second bracket 36 configured opposite to the first bracket 34 within the housing 32 of the CCDM 30. Additionally, the third mirror 250 is an adjustable mirror, i.e., the position of the third mirror 250 may be adjusted in order to accommodate larger lens magnification error.

As depicted in FIG. 2, light beams 230 and 232 strike at an incident surface ‘S7’ of the first mirror 220 along an optical path ‘L7’, when the document 40 is illuminated with the light source 210. The first mirror 220 then reflects the light beams 230 and 232 along an optical path ‘L8’ such that the light beams 230 and 232 strike at an incident surface ‘S8’ of the second mirror 240. Thereafter, the second mirror 240 reflects the light beams 230 and 232 along an optical path ‘L9’ such that the light beams 230 and 232 strike at an incident surface ‘S9’ of the third mirror 250. The third mirror 250 reflects the light beams 230 and 232 along an optical path ‘L10’ such that the light beams 230 and 232 strike at an incident surface ‘S10’ of the fourth mirror 260. Thereafter, the fourth mirror 260 reflects the light beams 230 and 232 along an optical path ‘L11’ such that the light beams 230 and 232 strike at an incident surface ‘S11’ of the fifth mirror 270. Subsequently, the fifth mirror 270 reflects the light beams 230 and 232 along an optical path ‘L12’ such that the light beams 230 and 232 strike at an incident surface ‘S12’ of the imaging lens unit 280 that forms an image corresponding to the document 40 onto the image sensor 290 by focusing the light beams 230 and 232 onto the image sensor 290.

The aforementioned arrangement of the first mirror 220 that is positioned further away from a plane of the document 40 makes dust inevitably less visible on the first mirror 220, as the light beams 230 and 232 may be more defocused when striking at the incident surface ‘S7’ of the first mirror 220. Further and as depicted in FIG. 2, the optical path ‘L12’ between the fifth mirror 270 and the imaging lens unit 280 is parallel to the optical path ‘L10’ between the third mirror 250 and the fourth mirror 260. Furthermore, the optical path ‘L12’ between the fifth mirror 270 and the imaging lens unit 280 is perpendicular to the optical path ‘L11’ between the fourth mirror 260 and the fifth mirror 270. Similarly, the optical path ‘L10’ between the third mirror 250 and the fourth mirror 260 is perpendicular to the optical path ‘L11’ between the fourth mirror 260 and the fifth mirror 270. Specifically, a plane connecting the image sensor 290, the imaging lens unit 280, and the fifth mirror 270 is parallel to a plane connecting the third mirror 250 and the fourth mirror 260, and to the plane of the document 40. Such an arrangement facilitates in aligning the plurality of mirrors and manufacturing of the CCDM 30 in an easy manner.

Further, the light beams 230 and 232 striking at/hitting the fourth mirror 260 are substantially narrower, thereby facilitating in saving space for the optical system 200. Accordingly, the scanner utilizing the CCDM 30 that includes the optical system 200 may be manufactured to have reduced vertical and horizontal dimensions as opposed to conventional scanners.

Based on the foregoing, the present disclosure provides an optical system (such as the optical systems 100 and 200) that facilitates in achieving compact dimensions for a scanner employing the optical system, while maintaining high optical image quality. In other words, a compact scanner having a reduced length and a reduced width as opposed to a conventional scanner may be obtained by employing the optical system of the present disclosure. Further, arrangement of the plurality of mirrors, the imaging lens unit and the image sensor with respect to a document to be scanned, as described in conjunction with FIGS. 1 and 2, facilitates in manufacturing the scanner employing the optical system in an easy manner.

The foregoing description of several embodiments of the present disclosure has been presented for purposes of illustration. It is not intended to be exhaustive or to limit the disclosure to the precise forms disclosed, and obviously many modifications and variations are possible in light of the above teaching. It is intended that the scope of the disclosure be defined by the claims appended hereto.

What is claimed is:

1. An optical system for a scanner, the optical system comprising:
at least one light source to illuminate a document to be scanned;
a plurality of mirrors comprising,
a first mirror positioned in a direction of the document, the first mirror adapted to receive a light beam from the document illuminated with the at least one light source, the first mirror further adapted to reflect the light beam,
a second mirror adapted to receive the light beam reflected from the first mirror, the second mirror further adapted to reflect the received light beam across an optical path between the first mirror and the document,
a third mirror positioned in proximity to the document, the third mirror adapted to receive the light beam reflected from the second mirror, the third mirror further adapted to reflect the received light beam across the optical path between the first mirror and the document,
a fourth mirror positioned adjacent to the second mirror and substantially opposite to the third mirror for receiving the light beam reflected from the third mirror, the fourth mirror further adapted to reflect the received light beam across an optical path between the first mirror and the second mirror, and an optical path between the second mirror and the third mirror, and
a fifth mirror positioned adjacent to the second mirror, and in a direction of the fourth mirror such that the second mirror is set between the fourth mirror and the fifth mirror, the fifth mirror adapted to receive the light beam reflected from the fourth mirror, the fifth mirror further adapted to reflect the received light beam across the optical path between the first mirror and the document;
an imaging lens unit positioned in a direction of the fifth mirror, and adapted to receive the light beam reflected from the fifth mirror; and
an image sensor positioned adjacent to the imaging lens unit, and adapted to sense an image formed by the imaging lens unit on the image sensor, the image being formed by focusing the received light beam on the image sensor, the image corresponding to the document.

2. The optical system of claim 1, wherein an optical path between the fifth mirror and the imaging lens unit is parallel to an optical path between the third mirror and the fourth mirror.

3. The optical system of claim 2, wherein the optical path between the third mirror and the fourth mirror is perpendicular to an optical path between the fourth mirror and the fifth mirror.

4. The optical system of claim 3, wherein the optical path between the fifth mirror and the imaging lens unit is perpendicular to the optical path between the fourth mirror and the fifth mirror.

5. The optical system of claim 1, wherein the first mirror is positioned optically farthest from the document among the plurality of mirrors, and in proximity to the imaging lens unit.

6. The optical system of claim 1, wherein the light beam reflected from the third mirror and received by the fourth mirror is a narrow light beam.

7. The optical system of claim 1, wherein the first mirror, the second mirror, the fourth mirror and the fifth mirror are mounted within a first bracket configured within the scanner.

8. The optical system of claim 7, wherein the third mirror is mounted within a second bracket configured opposite to the first bracket within the scanner.

9. The optical system of claim 1, wherein the third mirror is an adjustable mirror.
